(19) United States
(12) Patent Application Publication
(10) Pub. No.: US 2008/0310863 A1
(43) Pub. Date: Dec. 18, 2008

(54) PAPER TYPE DETERMINATION DEVICE

(75) Inventor: Yoshinori Honguh, Yokohama-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 11/733,951

(22) Filed: Apr. 11, 2007

(51) Int. Cl. G03G 15/00

(52) U.S. Cl. 399/16

(57) ABSTRACT

A paper type determination device of the invention forms images of plural light spots modulated at frequencies different from one another and aligned about a reference point on one surface of a sheet of paper subjected to determination. A photodetection device is disposed on the other surface side of the sheet of paper. In the photodetection device, a detection field of view having a center common with the reference point is provided, so that light coming within the detection field of view from the respective light spots by passing through the sheet of paper is detected. Signals superimposed in a detection signal from the photodetection device are distinguished on the basis of respective frequencies by a wave filter circuit. A diffusing characteristic of the sheet of paper is obtained from amplitudes of the signals distinguished on the basis of the respective frequencies, and the paper type is determined on the basis of this diffusing characteristic.

### BACKGROUND OF THE INVENTION

1. Field of the Invention

The present invention relates to a paper type determination device used in a printer or a copying machine to determine the type of paper as a recording material subjected to printing, and an image forming apparatus using the paper type determination device.

2. Description of the Related Art

With an electrophotographic image forming apparatus, such as a copying machine and a laser printer, the type of paper used as a recording material is automatically determined and the developing condition, the transfer condition, or the fixing condition is changed according to the determined paper type.

As a device that determines the paper type, there are devices disclosed in Japanese publications of unexamined applications described in the following.

In the device described in a Japanese publication of unexamined application, JP-A-2006-117363, light is irradiated to a first surface of a recording material and an image of the first surface of the recording material is taken and light is irradiated to a second surface of the recording material and an image of the first surface is taken by an imaging device. The surface roughness is detected from the images of the recording material taken by the imaging means, and the surface roughness thus detected is compared with an initial setting threshold value used to determine plural recording materials to determine which one of the plural recording materials is the paper type of the recording material on the basis of the comparison result.

In the device disclosed in another Japanese publication of unexamined application, JP-A-2006-23288, first irradiation means for irradiating light to a recording material to obtain reflected light from the surface of the recording material is provided, and second irradiation means for irradiating light to the recording material to obtain transmitted light from the recording material is provided. In addition, reading means for reading specularly reflected light and diffusively reflected light reflected on the recording material as the result of irradiation from the first irradiation means, and specularly transmitted light and diffusively transmitted light having passed through the recording material as the result of irradiation from the second irradiation means are provided separately. The type of the recording material is determined using a ratio of reflected light of an amount of specularly reflected light and an amount of diffusively reflected light and a ratio of transmitted light of an amount of specularly transmitted light and an amount of diffusively transmitted light obtained by these means.

Further, the device disclosed in still another Japanese publication of unexamined application, JP-A-2005-75469, irradiates light to a recording medium to measure light specularly reflected on the recording medium. The paper type is determined by utilizing that the surface roughness varies from recording medium to recording medium and each recording medium has different glossiness. In other words, the type of the recording medium is identified by comparing glossiness data acquired by measuring the specularly reflected light with a pre-stored threshold value. In this case, a detection error occurs when there is a variance in light receiving sensitivity at which reflected light is received. Hence, light is irradiated from a light-emitting portion in several different light-emitting amounts, and the type of the recording medium is identified according to a light receiving amount received at the light receiving portion when light is irradiated in a specific light-emitting amount.

These inventions use a CMOS sensor or plural light receiving elements, which complicates the device configuration and increases the cost. In addition, each is based on the technique to determine the type of paper using reflected light from the surface of paper. However, because this method is affected by the surface condition of paper, none of these inventions is fully acceptable as paper type determination means.

### SUMMARY OF THE INVENTION

An advantage of the invention is to provide a paper type determination device configured to determine the paper type by detecting the light diffusing characteristic of paper subjected to inspection, so that it is able to determine the paper type more precisely and can be formed simply at a low cost.

According to one aspect of the invention, a paper type determination device includes: an optical system that forms images of plural light spots modulated at frequencies different from one another and aligned about a reference point on one surface of a sheet of paper subjected to determination; a photodetection device that is disposed on the other surface side of the sheet of paper and provided with a detection field of view having a center common with the reference point, and detects light that comes within the detection field of view by passing through the sheet of paper from the respective light spots; a wave filter circuit that distinguishes signals superimposed in a detection signal from the photodetection device on the basis of respective frequencies; and a diffusing characteristic detection device that obtains a diffusing characteristic of the sheet of paper from values of amplitude of the signals at the respective frequencies distinguished by the wave filter circuit.

Also, according to another aspect of the invention, a paper type determination device includes: an optical system that forms images of plural light spots modulated with digital waveforms different from one another and aligned about a reference point on one surface of a sheet of paper subjected to determination; a photodetection device that is disposed on the other surface side of the sheet of paper and provided with a detection field of view having a center common with the reference point, and detects light that comes within the detection field of view by passing through the sheet of paper from the respective light spots; a waveform detection circuit that distinguishes signals superimposed in a detection signal from the photodetection device on the basis of respective digital waveforms; and a diffusing characteristic detection device that obtains a diffusing characteristic of the sheet of paper from values of amplitudes of the signals in the respective waveforms detected by the waveform detection circuit.

### BRIEF DESCRIPTION OF THE DRAWINGS

FIG. 1 is a view schematically showing the configuration of a paper type determination device according to a first embodiment of the invention;

FIG. 2 is a characteristic view used to describe the curves of diffusing characteristics in the first embodiment of the invention;

FIG. 3 is a view schematically showing the configuration of a paper type determination device according to a second embodiment of the invention;

FIG. 4 is a characteristic view used to describe the curves of diffusing characteristics in the second embodiment of the invention;

FIG. 5 is a view showing the configuration of an image forming apparatus according to a third embodiment of the invention; and

FIG. 6 is a view showing the configuration of a paper feeding portion in the image forming apparatus in the third embodiment of the invention.

### DETAILED DESCRIPTION OF THE INVENTION

Hereinafter, embodiments of the invention will be described in detail using the accompanying drawings as examples.

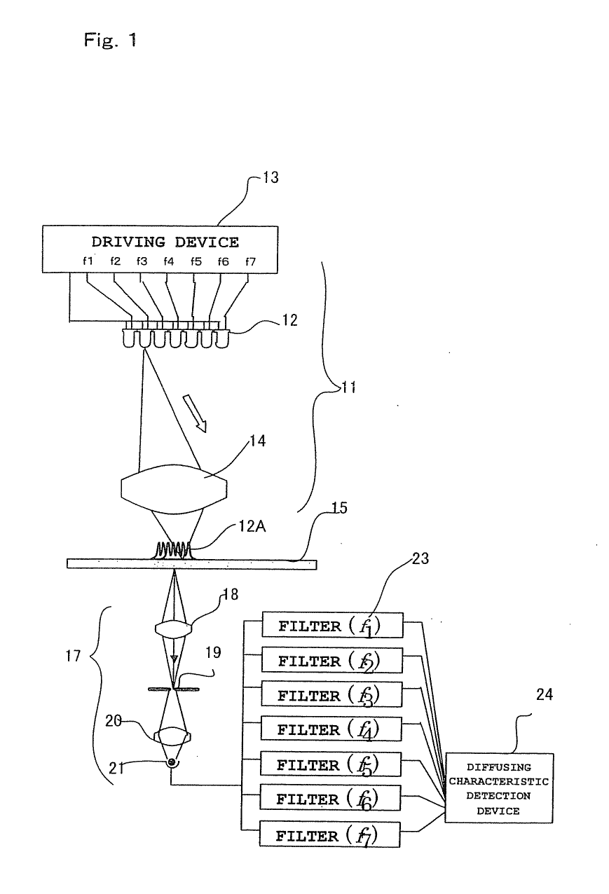

FIG. 1 shows a paper type determination device according to a first embodiment of the invention. Referring to FIG. 1, an optical system 11 for forming images of light emitting points has plural light emitting elements 12, such as LED's, a driving device 13 thereof, and an image forming lens 14. The plural light emitting elements 12 are aligned in a line about the reference point and they emit light to form plural light spots 12A aligned in a line on one surface (top surface in the drawing) of a sheet of paper 15 subjected to determination via the image forming lens 14. The light spots 12A pass through the sheet of paper 15 and appear on the other surface (the bottom surface in the drawing). The plural light emitting elements 12 are modulated at frequencies different from one another by the driving device 13 to emit plural light spots at different frequencies.

A photodetection device 17 is disposed on the other surface side (on the bottom surface side in the drawing) of the sheet of paper 15. The photodetection device 17 includes an image forming lens 18, an aperture 19 made in a shielding plate to form a detection field of view, a collective lens 20, and a photodetector 21. The image forming lens 18 forms images of the plural light spots 12A, which are formed on one surface of the sheet of paper 15 by the optical system 11 and then pass through the sheet of paper 15, within the detection field of view defined by the aperture 19. The aperture 19 is disposed so that the center thereof falls on the same position as the reference point, which is the center of alignment of the plural light emitting elements described above, and defines the specific detection field of view corresponding to the aperture area. The photodetector 21 receives detection light (light spots 12A) that passes through the aperture 19 to be collected by the collective lens 20, and outputs a detection signal.

A wave filter circuit 23 distinguishes signals superimposed in the detection signal (corresponding to detection light) outputted from the photodetection device 17 on the basis of their frequencies. To be more specific, the wave filter circuit 23 has filters that respectively filter out light emitting frequencies f1 through f7 of the light emitting elements 12 whose light emitting actions are controlled by the driving device 13. Upon input of the detection signal outputted from the photodetector 21, it distinguishes signals superimposed in the detection signal on the basis of the respective frequencies f1 through f7 and outputs the distinguished signals.

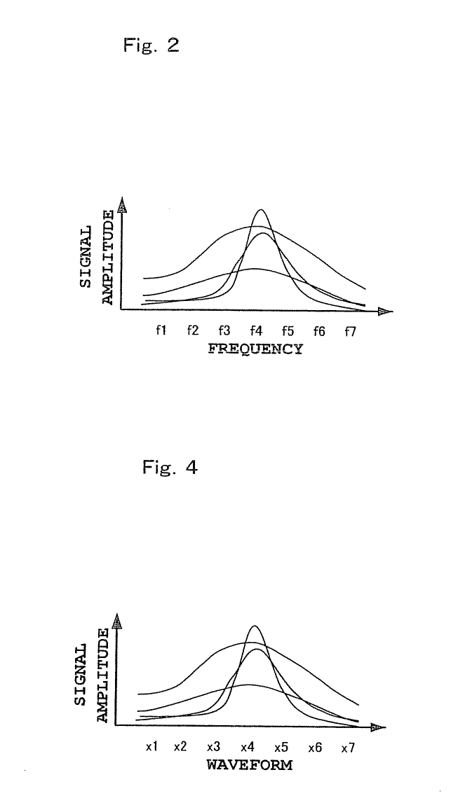

A diffusing characteristic detection device 24 obtains the diffusing characteristic (any one of curves of FIG. 2) of the sheet of paper 15 from the amplitude values of signals filtered out and distinguished on the basis of their frequency in the wave filter circuit 23. FIG. 2 shows an example of plural diffusing characteristics that vary from paper type to paper type.

In the configuration described above, the driving device 13 drives the plural light emitting elements 12 aligned in a line to emit light at frequencies that differ from one another with the respective light emitting elements. As the result of this light emission, images of the plural light spots 12A modulated at different frequencies are formed on the sheet of paper 15 via the image forming lens 14. These plural light spots 12A pass through the sheet of paper 15 and appear on the surface on the opposite side. In this instance, the plural light spots 12A blur due to the diffusing characteristic of the sheet of paper 15. In other words, the images of light spots blur more as the light diffusivity of the sheet of paper 15 becomes larger.

The photodetection device 17 disposed on the other surface side of the sheet of paper 15 allows the plural light spots having passed through the sheet of paper 15 to go incident on the light receiving surface of the photodetector 21 via the image forming lens 18, the aperture 19, and the collective lens 20 for the photodetector 21 to measure the light intensity and output a detection signal. Because plural light spots are detected, the frequency (f1 through f7) signals by which the driving device 13 drives the respective light emitting elements 12 to emit light are superimposed in the detection signal from the photodetector 21. Hence, the detection signal is filtered by the wave filter circuit 23 to distinguish the frequency signals on the basis of the respective frequencies f1 through f7.

The plural light emitting elements 12 are aligned in a line in the right-left direction about the reference point at the position concentric with the center of the detection field of view defined by the aperture 19. Hence, of the plural light emitting elements 12, light emitted from the light emitting element disposed at the center portion and controlled to emit light at the frequency f4 goes incident on the photodetector 21 at the highest intensity. On the contrary, intensity of light coming incident on the photodetector 21 becomes lower with increasing distances from the center.

Accordingly, the amplitudes of the signals distinguished by the wave filter circuit 23 on the basis of their frequencies show the characteristic curves as shown in FIG. 2. This tendency becomes more noticeable when the light diffusivity of the sheet of paper 15 is low and light spots blur less. To be more specific, the amplitude at the frequency f4 for the light spot positioned at the center of the detection field of view becomes large and the amplitudes decrease symmetrically and more rapidly with increasing distances from the center of the detection field of view, that is, in order of the frequencies f3 and f5, f2 and f6, and f1 and f7. This is because light at the respective light spots from the plural light emitting elements 12 is not diffused to a great extent on the sheet of paper 15 and the positional relation with the center of the detection field of view has a direct influence.

On the contrary, the curves of FIG. 2 become gentler as the diffusivity of the sheet of paper 15 becomes larger and the light spots blur more. To be more specific, even when the light spot at the frequency f4 is positioned at the center portion of the detection field of view, the intensity of light coming incident on the photodetector 21 becomes lower because the light is diffused significantly when it passes through the sheet of paper 15. The amplitude at the frequency f4 therefore does not become large to a great extent. On the other hand, when the light spot is deviated from the center of the detection field of view, the curves of FIG. 2 become gentler because the intensity of light coming incident on the photodetector 21 does not drop markedly owing to the diffusing effect.

As has been described, because the diffusing characteristics that vary with the types of paper can be obtained, as is shown in FIG. 2, the diffusing characteristic of each paper type is measured in advance and stored in the diffusing characteristic detection device 24. By comparing the diffusing characteristic (data) detected from the sheet of paper 15 subjected to determination with the pre-stored diffusing characteristics (data) of the respective paper types, it is possible to determine the paper type having the closest diffusing characteristic as being the paper type of the sheet of paper 15 subjected to determination.

In the determination method described above, the paper type is specified on the basis of the similarity of the diffusing characteristics. However, a curve used as the reference may be pre-stored, so that the type of paper is determined on the basis of a difference between the diffusing characteristic detected from a sheet of paper subjected to determination and the pre-stored diffusing characteristic used as the reference. To be more specific, because every curve of the diffusing characteristic decreases symmetrically having the peak at the center portion, by bringing the peak level of the diffusing characteristic curve detected from a sheet of paper subjected to determination into agreement with the peak level of the diffusing characteristic curve used as the reference and finding a difference at the other portion, it is possible to determine the paper type of the sheet of paper 15 subjected to determination on the basis of the difference.

Because the paper type is determined by allowing light to pass through a sheet of paper to obtain the diffusing characteristic for the light, it is possible to determine the paper type precisely without being affected by the surface condition of a sheet of paper as was the case in the related art. In addition, there is no need to use a large-scaled and expensive device, such as an image sensor, at the light receiving end, and it is therefore sufficient to provide a single light receiving element as the photodetector 21. The device is thus simplified and can be formed at a low cost.

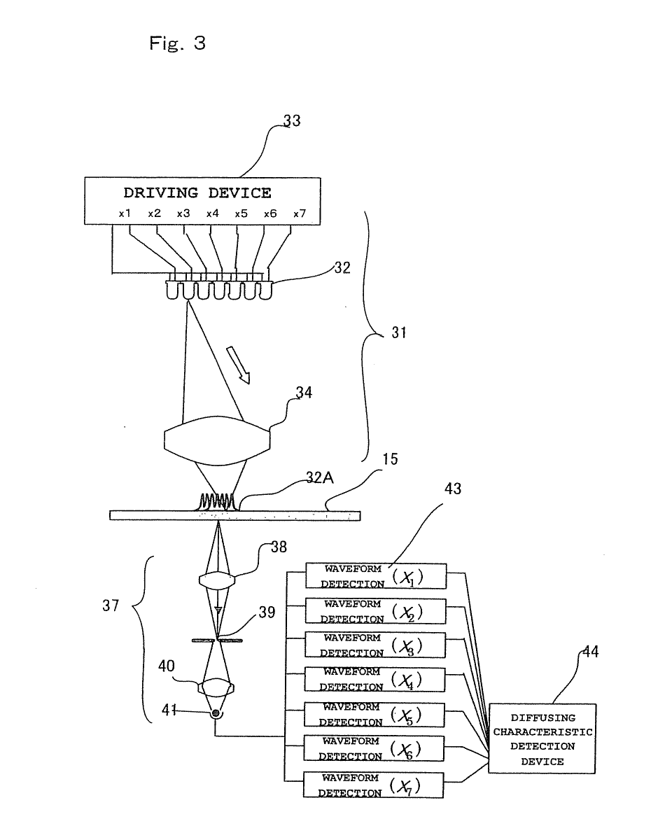

A second embodiment of the invention will now be described. FIG. 3 shows a paper type determination device of the second embodiment and it has an optical system 31 for forming images of light spots as with the first embodiment described above. The optical system 31 has plural light emitting elements 32, such as LED's, a driving device 33 thereof, and an image forming lens 34. The plural light emitting elements 32 are aligned in a line in the right-left direction about the reference point and they emit light to form plural light spots 32A aligned in a line on one surface (top surface in the drawing) of a sheet of paper 15 subjected to determination via the image forming lens 34. The light spots 32A pass through the sheet of paper 15 and appear on the other surface (the bottom surface in the drawing).

The plural light emitting elements 32 are modulated to digital waveforms that differ from one another by the driving device 33 and emit plural light spots. To be more specific, because digital waves of various waveforms can be shaped by combining plural rectangular waves having different wavelengths, the driving device 33 drives the plural light emitting elements 32 to emit light using digital waves x1 through x7 having waveforms different from one another.

A photodetection device 37 is disposed on the other surface side (on the bottom surface side in the drawing) of the sheet of paper 15. As with the first embodiment, the photodetection device 37 also has an image forming lens 38, an aperture 39 for forming a detection field of view, a collective lens 40, and a photodetector 41. The image forming lens 38 forms images of the light spots 32A, which are formed on one surface of the sheet of paper 15 by the optical system 31 and then pass through the sheet of paper 15, within the detection field of view defined by the aperture 39. The photodetector 41 receives detection light (light spots 12A) that passes through the aperture 39 to be collected by the collective lens 40, and outputs a detection signal.

A waveform detection circuit 43 distinguishes signal waves corresponding to the respective waveforms x1 through x7 in the detection signal outputted from the photodetection device 37, and outputs these signal waves.

A diffusing characteristic detection device 44 obtains the diffusing characteristic of the sheet of paper 15 (any one of the curves of FIG. 4) from the amplitude values of the signal waves corresponding to the waveforms x1 through x7 distinguished by the waveform detection circuit 43. FIG. 4 shows an example of plural diffusing characteristics that vary from paper type to paper type.

In the configuration described above, the driving device 33 drives the plural light emitting elements 32 aligned in a line to emit light in the digital waves having the waveforms x1 through x7 that differ from one another with the respective light emitting elements. As the result of this light emission, images of the plural light spots 32A are formed on the sheet of paper 15 via the image forming lens 34. These plural light spots 32A pass through to the other surface of the sheet of paper 15. In this instance, the plural light spots 32A blur due to the diffusing characteristic of the sheet of paper 15.

The photodetection device 37 disposed on the other surface side of the sheet of paper 15 allows the plural light spots 32A having passed through the sheet of paper 15 to go incident on the light receiving surface of the photodetector 41 via the image forming lens 38, the aperture 39, and the collective lens 40, so that the intensity of light is measured and a detection signal is outputted. Because plural light spots are detected, signals corresponding to the waveforms (x1 through x7) supplied to the respective light emitting elements 32 by the driving circuit 33 are superimposed in the detection signal from the photodetector 41. Hence, the waveform detection circuit 43 distinguishes signals superimposed in the detection signal on the basis of the waveforms x1 through x7.

Herein, the plural light emitting elements 32 are aligned in the right-left direction about the reference point common with the center of the detection field of view defined by the aperture 39. Hence, of the plural light emitting elements 32, light of the light spot disposed at the center portion and controlled to emit light with the waveform x4 goes incident on the photodetector 41 at the highest intensity. On the contrary, the intensity of light coming incident on the photodetector 41 decreases with increasing distances from the center.

Hence, the amplitudes of the signals distinguished by the waveform detection circuit 43 on the basis of the waveforms x1 through x7 show the characteristic curves as shown in FIG. 4. This tendency becomes more noticeable as the diffusivity of the sheet of paper 15 is low and the light spots blur less. To be more specific, the amplitude of the signal corresponding to the waveform x4 detected from the light spot at the center of the field of view becomes large and the amplitudes of the other light spots decrease symmetrically and more rapidly with increasing distances from the center of the detection field of view.

On the contrary, the curves of FIG. 4 become gentler as the diffusivity of the sheet of paper 15 becomes large and the light spots blur more. To be more specific, even when the light spot emitted in the waveform x4 is positioned at the center portion of the detection field of view, the intensity of light coming incident on the photodetector 41 becomes lower as the light is diffused significantly when it passes through the sheet of paper 15, and the amplitude of the detection signal does not become large to a great extent. On the other hand, even when the light spot is deviated from the center of the detection field of view, the curves of FIG. 4 become gentler because the intensity of light coming incident on the photodetector 41 does not drop markedly owing to the diffusing effect.

As has been described, because the diffusing characteristics that vary with the types of paper can be obtained, as is shown in FIG. 4, by measuring the diffusing characteristic of every paper type in advance to be stored in the diffusing characteristic detection device 44, it is possible to determine the paper type having the closest diffusing characteristic as being the paper type from the comparison between the detected diffusing characteristic (data) and the pre-stored diffusing characteristics (data) of the respective paper types.

Alternatively, by setting the curve used as the reference and bringing the peak level of the obtained diffusing characteristic curve into agreement with the peak level of the diffusing characteristic curve used as the reference to find a difference in the other portion, it is possible to determine the paper type that matches the detected diffusing characteristic.

Because the paper type is determined by allowing light to pass through a sheet of paper and obtaining the diffusing characteristic of the light, it is possible to determine the paper type precisely without being affected by the surface condition of a sheet of paper as was the case in the related art. In addition, there is no need to use a large-scaled and expensive device, such as an image sensor, at the light receiving end, and it is sufficient to provide a single light receiving element as the photodetector 41. The device is thus simplified and can be formed at a low cost.

A case where the paper type determination device described above is applied to an image forming apparatus will now be described.

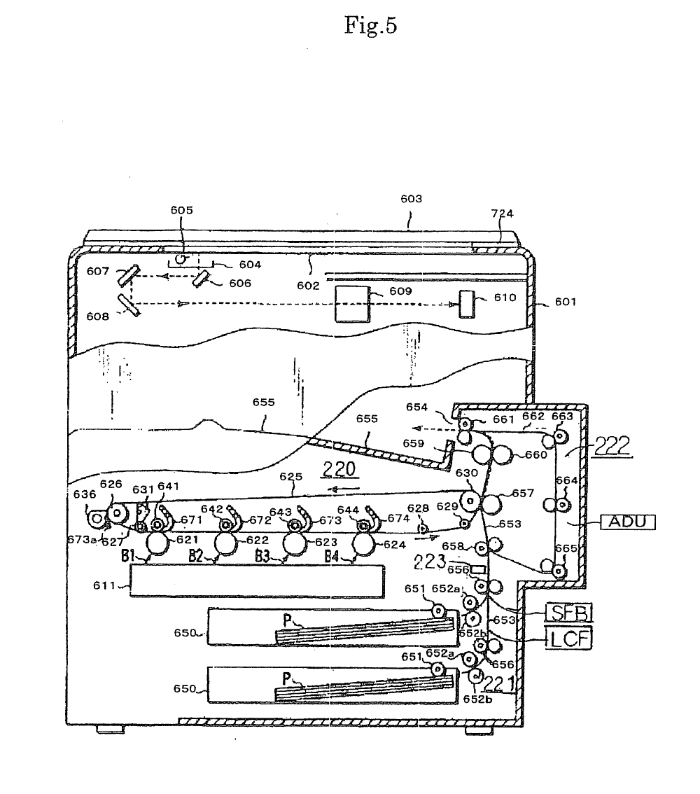

FIG. 5 is a view showing an example of the configuration of the image forming apparatus. As is shown in FIG. 5, an original document table 602 made of a transparent material, for example, a glass plate, for placing thereon an original document is provided at the top of an apparatus main body 601. Also, a cover 603 is provided to the apparatus main body 601 in an openable and closable manner to cover the original document table 602.

A scan unit that optically reads an image on the original document placed on the original document table 602 is provided on the bottom surface side of the original document table 602 inside the apparatus main body 601. For example, the scan unit has a carriage 604, reflection mirrors 606, 607, and 608 that reflect light emitted from an exposing lamp 605 and reflected on an original document, a magnifying lens block 609 that magnifies reflected light, and a CCD (Charge Coupled Device) 610. The carriage 604 includes an exposing lamp 605 that irradiates light toward the original document table 602, and it is configured to be able to reciprocate along the bottom surface of the original document table 602.

The carriage 604 exposes an original document placed on the original document table 602 to light by reciprocating while keeping the exposing lamp 605 lit ON. An image of the reflected light from the original document placed on the original document table 602 by this exposure is projected onto the CCD 610 by way of the reflection mirrors 606, 607, and 608 and the magnifying lens block 609. The CCD 610 outputs an image signal corresponding to the projected image of reflected light from the original document.

An image forming portion 220 is provided below the scan unit inside the apparatus main body 601. The image forming portion 220 includes, for example, a print engine and a process unit.

The print engine includes an exposing unit 611. The process unit includes photo conductive drums 621, 622, 623, and 624 disposed along the exposing unit 611, an endless transfer belt 625 disposed oppositely to the exposing unit 611 with the photo conductive drums 621, 622, 623, and 624 in between, a drive roller 626 that drives the transfer belt 625, a primary transfer rollers 641, 642, 643, and 644 disposed oppositely to the photo conductive drums 621, 622, 623, and 624, respectively, with the transfer belt 625 in between, and a transfer roller driving unit that drives the primary transfer rollers 641, 642, 643, and 644.

The transfer belt 625 is stretched over the drive roller 626, guide rollers 627, 628, and 629, and a driven roller 630, and runs to rotate in a semiclockwise direction upon receipt of motive power from the drive roller 626. The guide roller 627 is provided so as to be able to move up and down, and moves toward the transfer belt 625 upon receipt of turning of a cam 631. Accordingly, the guide roller 627 causes the transfer belt 625 to undergo displacement toward the photo conductive drums 621, 622, 623, and 624.

The image forming portion 220 forms an image according to image data (an image signal outputted from the CCD 610), and executes an image forming process to print the image on a sheet of paper being carried. To be more specific, an image signal outputted from the CCD 610 is processed appropriately and then supplied to the exposing unit 611. The exposing unit 611 emits a laser beam B1 corresponding to an image signal for yellow color to the photo conductive drum 621 for yellow color, a laser beam B2 corresponding to an image signal for magenta color to the photo conductive drum 622 for magenta color, a laser beam B3 corresponding to an image signal for cyan color to the photo conductive drum 623 for cyan color, and a laser beam B4 corresponding to an image signal for black color to the photo conductive drum 624 for black color.

By being moved (moved down) toward the transfer belt 625, the primary transfer rollers 641, 642, 643, and 644 bring the transfer belt 625 into contact with the photo conductive drums 621, 622, 623, and 624, respectively, so that visible images on the photo conductive drums 621, 622, 623, and 624 are transferred onto the transfer belt 625.

Unillustrated drum cleaner, erasing lamp, charging unit, and developing unit are sequentially provided on the periphery of the photo conductive drum 621. The drum cleaner has a drum cleaning blade that comes into contact with the surface of the photo conductive drum 621, and scrapes off a developing material remaining on the surface of the photo conductive drum 621 using the drum cleaning blade.

The erasing lamp erases charges remaining on the surface of the photo conductive drum 621. By applying a high voltage to the photo conductive drum 621, the charging unit positively charges the surface of the photo conductive drum 621. The laser beam B1 emitted from the exposing unit 611 is irradiated onto the charged surface of the photo conductive drum 621. As the result of this irradiation, an electrostatic latent image is formed on the surface of the photo conductive drum 621. The developing unit turns the electrostatic latent image on the photo conductive drum 621 into a visible image by supplying a developing material (toner particles) in yellow color to the surface of the photo conductive drum 621.

Likewise, the other photo conductive drums 622, 623, and 624 turn electrostatic latent images on the surfaces of the photo conductive drums 622, 623, and 624 into visible images using developing materials in the corresponding colors.

At the position opposing the drive roller 626 in the image forming portion 220, a cleaner 636 is provided with the transfer belt 625 in between. The cleaner 636 has a cleaning blade 636a that comes into contact with the transfer belt 625, and scrapes off a developing material remaining on the transfer belt 625 using the cleaning blade 636a.

The print mode is changed as follows. Hooks 671, 672, 673, and 674 are provided in close proximity to the primary transfer rollers 641, 642, 643, and 644, respectively. The hooks 671, 672, 673, and 674 engage, respectively, with the shafts of the primary transfer rollers 641, 642, 643, and 644 to lift up the corresponding shafts while they rotate, so that they move the primary transfer rollers 641, 642, 643, and 644 in directions to be spaced apart from the photo conductive drums 621, 622, 623, and 624, respectively. The print mode is changed to a full-color mode, a totally spaced-apart mode, and a monochrome mode by moving none of the primary transfer rollers 641, 642, 643, and 644 or by changing a combination of rollers to be moved.

Paper accommodation mechanism and feeding mechanism will now be described. Plural paper cassettes 650 to accommodate sheets of paper therein are provided below the exposing unit 611. A large number of sheets of paper P of different paper types in a stacked state are accommodated in these paper cassettes 650. A paper feeding mechanism 221 that feeds sheets of paper one by one from the top of sheets of paper within the paper cassette 650 is provided at an outlet portion (on the right in the drawing) of each paper cassette 650. Sheets of paper P are taken out one by one from either one of the paper cassettes 650 by the corresponding paper feeding mechanism 221. Each of the taking-out paper feeding mechanisms 221 includes a pickup roller 651, a paper feeding roller 652a, and a separation roller 652b, and separates sheets of paper P taken out from the paper cassette 650 and feeds them one by one to a paper carrying path 653.

The paper carrying path will now be described. The paper carrying path 653 extends to a paper discharge port 654 at the top by way of the driven roller 630 in the image forming portion 220. The paper discharge port 654 faces a paper discharge portion 655 that continues to the outer peripheral surface of the apparatus main body 601. In addition, a carrying roller pair 656 is provided in close proximity to each paper feeding mechanism 221 at the start end of the carrying path 653. When a sheet of paper is fed from either one of the paper feeding mechanisms 221, the paper carrying path 653 carries the fed sheet of paper to the paper discharge portion 655.

In addition, a secondary transfer roller 657 is provided at a position opposing the driven roller 630 with the transfer belt 625 in between somewhere in the middle of the paper carrying path 653. A registration roller pair 658 is provided at a position upstream from the driven roller 630 and the secondary transfer roller 657 in the carrying direction.

The registration roller pair 658 sends a sheet of paper P into a space between the transfer belt 625 and the secondary transfer roller 657 at timing in sync with a transfer operation, which is an operation to transfer an image formed of a developing material (toner particles) onto a sheet of paper by the transfer belt 625 and the secondary transfer roller 657. The secondary transfer roller 657 executes printing by transferring a visible image formed of a developing material (toner particles) and transferred onto the transfer belt 625 onto the sheet of paper P while sandwiching the sheet of paper P sent from the registration roller pair 658 with the transfer belt 625 on the driven roller 630. As has been described, the registration roller pair 658 carries the sheet of paper P to the image forming unit 220 having the transfer belt 625 and the secondary transfer roller 657 in sync with the transfer operation of the image forming portion 220.

A thermal fixing heat roller 659 and a press roller 660 that comes into contact with the heat roller 659 are provided in the paper carrying path 653 at a position downstream from the secondary transfer roller 657. An image transferred onto the sheet of paper P is fixed thereon by the heat roller 659 and the press roller 660. A paper discharge roller pair 661 is provided at the terminal end of the paper carrying path 653.

An automatic duplex unit (herein after, abbreviated to ADU) 222 may be provided to the apparatus main body 601. The ADU 222 is provided for the terminal end of the paper carrying path 653 and the inlet of the registration roller pair 658 to communicate with a sub-carrying path 662, which is a path to carry a sheet of paper P inside the ADU 222. The sub-carrying path 662 branches from the paper carrying path 653 at the downstream end with respect to the image forming apparatus 220 (the terminal end of the paper carrying path 653) and merges with the paper carrying path 653 at the upstream end with respect to the image forming portion 220 (the position upstream from the registration roller pair 658).

The sub-carrying path 662 is used to turn over the sheet of paper P for duplex printing. The sub-carrying path 662 is provided with paper feeding roller pairs 663, 664, and 665, and the ADU 222 carries backward the sheet of paper P being carried to the paper discharge portion 655 from the image forming portion 220, so that it is carried through the sub-carrying path 662 to go into the paper carrying path 653 at the upstream end of the image forming portion 220. When carried in this manner, the sheet of paper P is turned over.

After the sheet of paper P returned to the upstream end of the image forming portion 220 by the sub-carrying path 662 goes into the paper carrying path 653, it is sent to the transfer position at which the transfer belt 625 and the secondary transfer belt 657 come into contact with each other in sync with the transfer operation of the image forming portion 220 by the registration roller pair 658. In this manner, a visible image on the transfer belt 625 is also transferred onto the back surface of the sheet of paper P and printed thereon.

The sub-carrying path 662 in the ADU 222 shifts to a state where it performs an operation to turn over the sheet of paper P as described above when duplex printing is specified from a computer or the like connected to the apparatus main body 601 by way of an operation panel 724 provided to the apparatus main body 601 or via the network.

A device additionally provided will now be described. In the example of the apparatus main body 601 shown in FIG. 5, two paper cassettes 650 are provided as paper feeding sources. However, three or more paper cassettes 650 may be provided to the apparatus main body 601. In addition, although it is not shown in the drawing, a manual paper feeding mechanism (herein after, referred to as the SFB) or a paper feeder of a large capacity (herein after, referred to as the LCF) that is a paper feeding mechanism capable of accommodating a stack of several thousands of sheets of paper may be provided. These SFB and LCF are provided to the apparatus main body 601 in such a manner that their paper feeding paths merge with the paper carrying path 653.

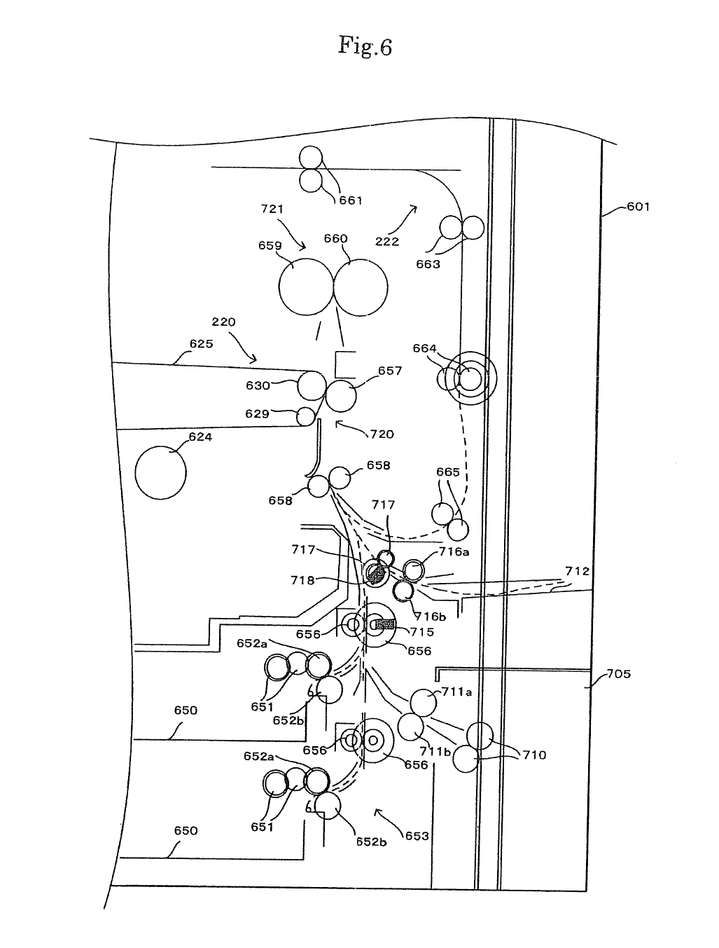

The installment position of the paper type determination device will now be described. FIG. 6 is a view showing in detail a portion in close proximity to the paper carrying path 653. Hereinafter, the heat roller 659 and the press roller 660 are collectively referred to as a fixing portion 721. The fixing portion 721 fixes a developing material (toner particles) onto a recording medium P on which is transferred the developing material by carrying the sheet of paper P while the sheet of paper P is heated by the heat roller 659 and a pressure is applied thereto by the press roller 660.

Although it is not shown in the drawing, a control portion is provided to the apparatus main body 601. The control portion can be formed of, for example, a CPU, a memory, such as a ROM, and a RAM, and an LSI. The control portion controls the temperature of the heat roller 659. For example, the heat roller 659 stands by while maintaining a pre-determined temperature in response to the type of the sheet of paper P in a case where there is no signal from the control portion, and in a case where it receives a signal instructing to start the fixing, it changes the temperature according to the instruction.

Because the apparatus main body 601 is configured as described above to fix the developing material, the paper type determination device is installed upstream from the fixing portion 721 in the paper carrying path 653.

In a case where a single paper type determination device is used, it is installed at a first installment position 223 shown in FIG. 5. The first installment position 223 is a position in the paper carrying path 653 upstream with respect to the image forming portion 220 and upstream from the registration roller pair 658. In a case where the SFB 712 or the LCF 705 is provided, the first installment position 223 is a position downstream from the merging point of the paper feeding paths from the SFB 712 and the LCF 705 and the paper carrying path 653. The paper type determination device is installed to face the surface of a sheet of paper being carried.

By installing the paper type determination device at the first installment position 223, it is possible to detect the type of a recording medium P carried through the recording medium carrying path 653 from all the feeding sources of the recoding media by a single paper type determination device.

For some type of the image forming apparatus, there is a case where the paper type determination device cannot be installed at the first installment position 223 due to the relation of the arrangement of the respective components inside the apparatus main body 601. Also, there is a type to which the SFB 712 is attached as an option. In such a case, the paper type determination device can be provided to two points specified below.

A description will be given using FIG. 6. A second installment position 715 is in the paper carrying path 653 and it is a position upstream from the image forming portion 220 in the paper carrying path 653 and upstream from the registration roller pair 658, and it is also a position downstream from the paper feeding roller 652a and the separation roller 652b for the cassette device 650 at the uppermost stage and downstream from the merging position of the paper feeding path from the LCF 705 and the paper 653. The paper type determination device is installed to face the surface of a sheet of paper being carried. The paper type determination device may be installed in close proximity to a carrying roller pair 656 present at the second installment position 715.

A third installment position 718 is a position upstream from the merging position of the paper feeding path from the SFB 712 and the paper carrying path 653. The paper type determination device is installed to face the surface of a sheet of paper being carried. The paper type determination device may be provided in close proximity to a carrying roller pair 717 present at the third installment position 718.

By installing the paper type determination devices at the second installment position 715 and the third installment position 718, it is possible to achieve an effect that the paper type determination device is installed at the installment position 718 when the need arises in the image forming apparatus of a type to which the SFB 712 is attached as an option.

An applied example regarding the processing of a signal indicating the determination result and outputted from the paper type determination device will now be described. The operation panel 724 used to choose the type of a sheet of paper P and to make an input for displaying the information or setting the data is attached to the top surface of the apparatus main body 601. The control panel 724 is connected to the control portion. The control portion controls speeds of motors that drive the respective rollers to rotate for carrying a sheet of paper, and it also suspends and resumes the carrying of a sheet of paper.

Initially, the control portion stores the default type of paper or the type of paper inputted from the operation panel 724 into the memory as the set paper and sets the stand-by temperature of the heat roller 659 corresponding to this paper.

Subsequently, a paper recording medium P is carried and the paper type determination device determines the type of the recording medium P. The paper type determination device then outputs a signal indicating the determination result to the control portion. The control portion sets, for example, the carrying speed of a sheet of paper, the rotating speed of the fixing portion 721, the temperature of the heat roller 659 during the fixing according to the determination result, and transmits instructions to these components.

As has been described, in the image forming apparatus of this application example, the set paper is set first, and the conditions, such as the speed and the temperature during the fixing, are set further according to the type of paper determined by the paper type determination device. Hence, there is an effect that it is possible to set the conditions during fixing in detail according to the type of paper and to execute the fixing swiftly.

What is claimed is:

1. A paper type determination device, comprising:
an optical system that forms images of plural light spots modulated at frequencies different from one another and aligned about a reference point on one surface of a sheet of paper subjected to determination;
a photodetection device that is disposed on the other surface side of the sheet of paper and provided with a detection field of view having a center common with the reference point, and detects light that comes within the detection field of view from the respective light spots by passing through the sheet of paper;
a wave filter circuit that distinguishes signals superimposed in a detection signal from the photodetection device on the basis of respective frequencies; and
a diffusing characteristic detection device that obtains a diffusing characteristic of the sheet of paper from values of amplitude of the signals at the respective frequencies distinguished by the wave filter circuit.

2. The paper type determination device according to claim 1, wherein:
the plural light spots are formed by providing plural light emitting elements to correspond to respective light spot positions.

3. The paper type determination device according to claim 1, wherein:
the diffusing characteristic detection device has a capability of comparing the obtained diffusing characteristic with pre-set diffusing characteristics of sheets of paper of respective types and determining the paper type of the sheet of paper on the basis of a similarity there between.

4. The paper type determination device according to claim 1, wherein:
the diffusing characteristic detection device has a capability of comparing the obtained diffusing characteristic with a pre-set diffusing characteristic used as a reference and determining the paper type of the sheet of paper on the basis of a difference there between.

5. A paper type determination device, comprising:
an optical system that forms images of plural light spots modulated with digital waveforms different from one another and aligned about a reference point on one surface of a sheet of paper subjected to determination;
a photodetection device that is disposed on the other surface side of the sheet of paper and provided with a detection field of view having a center common with the reference point, and detects light that comes within the detection field of view from the respective light spots by passing through the sheet of paper;
a waveform detection circuit that distinguishes signals superimposed in a detection signal from the photodetection device on the basis of respective digital waveforms; and
a diffusing characteristic detection device that obtains a diffusing characteristic of the sheet of paper from values of amplitudes of the signals in the respective waveforms detected by the waveform detection circuit.

6. The paper type determination device according to claim 5, wherein:
the plural light spots are formed by providing plural light emitting elements to correspond to respective light spot positions.

7. The paper type determination device according to claim 5, wherein:
the diffusing characteristic detection device has a capability of comparing the obtained diffusing characteristic with pre-set diffusing characteristics of sheets of paper of respective types and determining the paper type of the sheet of paper on the basis of a similarity there between.

8. The paper type determination device according to claim 5, wherein:
the diffusing characteristic detection device has a capability of comparing the obtained diffusing characteristic with a pre-set diffusing characteristic used as a reference and determining the paper type of the sheet of paper on the basis of a difference there between.

9. An image forming apparatus that forms an image on a sheet of paper, comprising:
a paper feeding mechanism that feeds sheets of paper one by one;
a paper carrying path that carries a sheet of paper fed from the paper feeding mechanism to a paper discharge portion;
an image forming portion that is disposed upstream from the paper discharge portion in the paper carrying path and executes an image forming process to print an image according to image data on the sheet of paper carried by the paper carrying path;
a fixing portion that fixes a developing material on the sheet of paper at a specific temperature;
a paper type determination device that is provided upstream from the fixing portion in the paper carrying path and detects a type of the sheet of paper; and
a control portion that changes a condition under which the image forming process is executed in response to the type of the sheet of paper determined by the paper type determination device,
wherein the paper type determination device comprises:
an optical system that forms images of plural light spots modulated at frequencies different from one another and aligned about a reference point on one surface of a sheet of paper subjected to determination;
a photodetection device that is disposed on the other surface side of the sheet of paper and provided with a detection field of view having a center common with the reference point, and detects light that comes within the detection field of view from the respective light spots by passing through the sheet of paper;
a wave filter circuit that distinguishes signals superimposed in a detection signal from the photodetection device on the basis of respective frequencies; and
a diffusing characteristic detection device that obtains a diffusing characteristic of the sheet of paper from values of amplitude of the signals at the respective frequencies distinguished by the wave filter circuit.

10. An image forming apparatus that forms an image on a sheet of paper, comprising:
a paper feeding mechanism that feeds sheets of paper one by one;
a paper carrying path that carries a sheet of paper fed from the paper feeding mechanism to a paper discharge portion;
an image forming portion that is disposed upstream from the paper discharge portion in the paper carrying path and executes an image forming process to print an image according to image data on the sheet of paper carried by the paper carrying path;
a fixing portion that fixes a developing material on the sheet of paper at a specific temperature;
a paper type determination device that is provided upstream from the fixing portion in the paper carrying path and detects a type of the sheet of paper; and
a control portion that changes a condition under which the image forming process is executed in response to the type of the sheet of paper determined by the paper type determination device,
wherein the paper type determination device comprises:
an optical system that forms images of plural light spots modulated with digital waveforms different from one another and aligned about a reference point on one surface of a sheet of paper subjected to determination;
a photodetection device that is disposed on the other surface side of the sheet of paper and provided with a detection field of view having a center common with the reference point, and detects light that comes within the detection field of view from the respective light spots by passing through the sheet of paper;
a waveform detection circuit that distinguishes signals superimposed in a detection signal from the photodetection device on the basis of respective digital waveforms; and
a diffusing characteristic detection device that obtains a diffusing characteristic of the sheet of paper from values of amplitudes of the signals in the respective waveforms detected by the waveform detection circuit.
